(19) United States
(12) Patent Application Publication
(10) Pub. No.: US 2005/0169264 A1
(43) Pub. Date: Aug. 4, 2005

(54) Multi-protocol label switching (MPLS) edge router

(76) Inventors: Jin-Hyoung Kim, Suwon-si (KR); Byung-Gu Choe, Seoul (KR); Yong-Seok Park, Yongin-si (KR)

Correspondence Address: Robert E. Bushnell, Suite 300, 1522 K Street, N.W., Washington, DC, 20005-1202, US

(21) Appl. No.: 11/020,128

(22) Filed: Dec. 27, 2004

(30) Foreign Application Priority Data
Jan. 29, 2004 (KR) 2004-5857

(51) Int. Cl. H04L 12/56

(52) U.S. Cl. 370/389

(57) ABSTRACT

A Multi-Protocol Label Switching (MPLS) edge router includes: a label information table storage unit adapted to store NextHop information to route a label packet to an Internet Protocol (IP) network and interface information to transmit the label packet to a NextHop; an Internet Protocol routing module adapted to manage and maintain the label information table storage unit; and an MPLS forwarding engine adapted to delete a label by accessing the label information table storage unit and searching the interface information and the NextHop information stored therein, and transmitting an IP packet to the corresponding interface upon receiving the label packet to be transmitted to the IP network.

### CLAIM OF PRIORITY

This application makes reference to, incorporates the same herein, and claims all benefits accruing under 35 U.S.C. §119 from an application for MPLS EDGE ROUTER HAVING MULTIPLE LOOK-UP LOAD REDUCTION FUNCTION AND METHOD FOR CONTROLLING THE SAME earlier filed in the Korean Intellectual Property Office on 29 Jan. 2004 and there duly assigned Serial No. 2004-5857.

### BACKGROUND OF THE INVENTION

1. Field of the Invention

The present invention relates to an MPLS (Multi-Protocol Label Switching) edge router and, more particularly, to an MPLS edge router and a method of controlling the router and a program storage device, readable by a machine, tangibly embodying a program of instructions executable by the machine to perform the method of controlling the router, where an Internet Protocol (IP) NextHop segment table including NextHop information to route a label packet to an IP network and interface information to transmit the label packet to a NextHop is included in a label information table storage unit to reduce multiple look-up loading upon transmitting the label packet to the IP network.

2. Description of the Related Art

Lately, the number of Internet users has sharply increased and users' needs have been changed from general data transmission aiming at the best-effort service which is a characteristic of an existing Internet to various services which need a Quality of Service (QoS) such as voice and streaming video on the Internet.

A router, which is core equipment in the existing Internet network, executes a routing protocol with a destination in order to generate information (routing information) for transferring packets transmitted to the router to the destination and exchanges the routing information with the destination.

The routing protocol is divided into an Interior Gateway Protocol (IGP) and an Exterior Gateway Protocol (EGP).

The IGP includes a Routing Information Protocol (RIP) and an Open Shortest Path First (OSPF), and a representative protocol of the EGP is a Border Gateway Protocol (BGP).

A protocol operated in an Autonomous System (AS) is referred to as the IGP, and a protocol operated among the AS is referred to as the EGP.

The routers currently used in the Internet operate the IGP and the BGP and produce information transferred to the destination of the packets, wherein the information is referred to as a routing table and a tuple in the routing table is referred to as a routing entry.

The BGP is a protocol which is generally used between gateway nodes in the Internet, and the routing table includes accessible (that is, connectable) addresses and an attribute which is related to a route to each of the nodes to select an optimal path. The BGP is an IP application protocol, which communicates using the Transmission Control Protocol (TCP) and informs neighboring nodes of its changed information by sending updated routing information when a change is sensed in any node.

An Internet which is mainly based on an Ethernet is a technology suitable to transfer general data such as a File Transfer Protocol (FTP). A technology referred to as Multi-protocol Label Switching (MPLS) has been developed to meet with demands of the users such as a real-time data transfer.

The MPLS is a protocol corresponding to between layer 2 and layer 3 of the communication protocol and is a technology in which the routers forward and receive a label of the layer 2 to each other and attach the label to a header of the packet. Each of the routers can transfer the packet without any processing up to the layer 3 by transferring the data with reference to only the label attached to the MPLS header information of the packet.

In other words, the MPLS classifies a Forwarding Equivalence Class (FEC) using an identical destination IP address as a key on the basis of a forwarding table generated by an existing routing protocol, and then endows a routing entry belonging to the same FEC with the same label. Accordingly, the packets having the same destination have the same label, and are transferred to the destination by label switching at a high speed.

In the MPLS, a path is set between a transmission side and a reception side, which is called a Label Switched Path (LSP). The LSP has a connection-oriented characteristic, so that it is possible to forward Internet traffic in real-time. The protocol used to switch the labels to each other may use either the BGP or the LDP.

Such an MPLS network consists of an End System to perform a function of an existing router and Label Switching Routers (LSRs). The LSR can be divided into an Edge LSR (hereinafter, referred to as a Label Edge Router: LER) arranged on a connection point with the existing network and a Core LSR (hereinafter, referred to as an ‘LSR’) arranged in a corresponding MPLS network according to its function.

An MPLS control protocol stack to support the corresponding MPLS function includes a Label Distribution Protocol (LDP) layer to forward and receive a label value between corresponding LSRs, which sets an MPLS path to transmit the L3 packet using the corresponding LDP layer using an MPLS technique. The path is called a Label Switched Path (LSP).

On the other hand, an MPLS data protocol stack to construct the corresponding MPLS network has a structure including a protocol included in the existing router and an MPLS layer in each corresponding LSR. Each LER is divided into an inlet LER and an outlet LER according to a flow of the packet, attaches a new label stack to the L3 packet transmitted from the End System in the MPLS layer of the inlet LER in order to transmit the L3 packet using the MPLS technique and transmits them to the MPLS network. The MPLS data protocol stack transmits the corresponding L3 packet to the outlet LER at a high speed by switching the label value in the MPLS layer of the core LSR arranged in the MPLS network.

The label stack attached to the L3 packet is removed in the MPLS layer of the corresponding outlet LER and again transmitted to the IP layer of the End System.

The following patents each discloses features in common with the present invention but do not teach or suggest the inventive features specifically recited in the present application: U.S. patent application No. 2003/0099235 to Shin et al., entitled METHOD OF ROUTING POINT-TO-MULTIPOINT TRAFFIC ON AN MPLS NETWORK, published on May 29, 2003; U.S. patent application No. 2003/0053414 to Akahane et al., entitled METHOD OF TRANSFERRING PACKETS AND ROUTER DEVICE THEREFOR, published on Mar. 20, 2003; U.S. patent application No. 2002/0172155 to Kasvand-Harris et al., entitled METHOD AND SYSTEM FOR ALLOCATING AND CONTROLLING LABELS IN MULTI-PROTOCOL LABEL SWITCHED NETWORKS, published on Nov. 21, 2002; U.S. patent application No. 2004/0100968 to Kim, entitled MULTIPROTOCOL LABEL SWITCHING DEVICE WITH DISTRIBUTED FORWARD ENGINES AND METHOD THEREOF, published on May 27, 2004; U.S. patent application No. 2003/0065772 to Hata, entitled MPLS PACKET STATISTICAL PROCESS METHOD AND STATISTICAL PROCESS APPARATUS, published on Apr. 3, 2003; U.S. patent application No. 2003/0212927 to Navar et al., entitled FAULT-PROTECTION MECHANISM FOR PROTECTING MULTI-PROTOCOL-LABEL SWITCHING (MPLS) CAPABILITY WITHIN A DISTRIBUTED PROCESSOR ROUTER OPERATING IN AN MPLS NETWORK, published on Nov. 13, 2003; U.S. patent application No. 2003/0210705 to Seddigh et al., entitled SYSTEM AND METHOD FOR DISTRIBUTED RESOURCE RESERVATION PROTOCOL-TRAFFIC ENGINEERING (RSVP-TE) HITLESS RESTART IN MULTI-PROTOCOL LABEL SWITCHING (MPLS) NETWORK, published on Nov. 13, 2003; U.S. patent application No. 2004/0088430 to Busi et al., entitled METHODS OF PROCESSING DATA PACKETS AT LAYER THREE LEVEL IN A TELECOMMUNICATION EQUIPMENT, published on May 6, 2004; U.S. patent application No. 2004/0052256 to Hameleers et al., entitled METHOD FOR TRANSMITTING DATA PACKETS IN A CELLULAR COMMUNICATION NETWORK, published on Mar. 18, 2004; U.S. patent application No. 2004/0025054 to Xue, entitled MPLS/BGP VPN GATEWAY-BASED NETWORKING METHOD, published on Feb. 5, 2004; U.S. patent application No. 2003/0185217 to Ganti et al., entitled LABEL DISTRIBUTION PROTOCOL SUPPORTING MULTIPLE CLASSES OF SERVICE IN A MULTI PROTOCOL LABEL SWITCHING (MPLS) NETWORK, METHODS AND MPLS NETWORK USING THEREOF, published on Oct. 2, 2003; and U.S. patent application No. 2003/0161264 to Ho et al., entitled SYSTEM, DEVICE, AND METHOD FOR TRAFFIC AND SUBSCRIBER SERVICE DIFFERENTIATION USING MULTIPROTOCOL LABEL SWITCHING, published on Aug. 28, 2003.

### SUMMARY OF THE INVENTION

It is an object of the present invention to provide an MPLS edge router and method for controlling the same, where a table structure is designed to avoid a double lookup which is performed to transfer a label packet to an IP network, so that a factor to cause a delay in a real packet transfer can be reduced.

It is another object of the present invention to provide an MPLS edge router and method of controlling the router, where a table structure designed to avoid a double look-up reflects changed routing information, to properly effect packet transfer even though NextHop information has changed.

According to an aspect of the present invention, an Multi-Protocol Label Switching (MPLS) edge router is provided comprising: a label information table storage unit adapted to store NextHop information to route a label packet to an Internet Protocol (IP) network and interface information to transmit the label packet to a NextHop; an Internet Protocol routing module adapted to manage and maintain the label information table storage unit; and an MPLS forwarding engine adapted to delete a label by accessing the label information table storage unit and searching the interface information and the NextHop information stored therein, and transmitting an IP packet to the corresponding interface upon receiving the label packet to be transmitted to the IP network.

Preferably, the label information table storage unit comprises: an Internet Protocol NextHop segment table including an index field, an IP out interface index field including an interface address for IP routing, and a NextHop address field including the NextHop information for the IP routing; an OutSegment Table including an index field, a label field, an interface index field, a NextHop address, and an IP NextHop segment index field adapted to access a corresponding entry of the IP NextHop segment table; a Cross Connect Table including an Index field, and an OutSegment Index field adapted to access a corresponding entry of the OutSegment Table; and an InSegment Table including an interface index field of interface addresses to receive label packets, a label field, and a Cross Connect Table Index field adapted to locate a corresponding entry of the Cross Connect Table.

Preferably, the IP routing module is adapted to update the NextHop information of the label information table upon the NextHop information being changed in the included routing table.

Preferably, the MPLS forwarding engine comprises: a packet reception unit adapted to receive the label packet; a look-up unit adapted to access the label information table; a control unit adapted to delete the label by accessing the label information table via the look-up unit, to search the interface information and the NextHop information by accessing the label information table via the look-up unit, and to transmit the IP packet to the corresponding interface information, upon receiving the label packet to be transmitted to the IP network from the packet reception unit; and a packet transmission unit adapted to transmit the label removed IP packet to the corresponding interface under the control of the control unit.

Preferably, the look-up unit comprises: an InSegment Table look-up unit adapted to search an index of a Cross Connect Table by accessing an InSegment Table; a cross connect segment table look-up unit adapted to search an index of an OutSegment Table by accessing a cross connect segment; an OutSegment Table look-up unit adapted to search an index of an Internet Protocol NextHop segment table by accessing the OutSegment Table; and an IP NextHop segment table look-up unit adapted to search the interface information and the NextHop information by accessing the IP NextHop segment table.

According to another aspect of the present invention, a method of controlling a Multi-Protocol Label Switching (MPLS) edge router is provided, the method comprising: generating an Internet Protocol NextHop segment table including NextHop information to route a label packet to an Internet Protocol (IP) network and interface information to transmit the label packet to the NextHop; extending an OutSegment Table to further include an index field to access a corresponding entry of the Internet Protocol NextHop segment table in the OutSegment Table consisting of an out interface index field and a NextHop IP address field; locating an index with respect to the corresponding entry of the IP NextHop segment table with reference to a label information table upon receiving the label packet and deleting the label with an MPLS forwarding engine; and locating an entry corresponding to the Internet Protocol NextHop segment table index obtained via the label information table from the Internet Protocol NextHop segment table, and transmitting the IP packet to a corresponding interface via the interface information and the NextHop information of the corresponding entry with the the MPLS forwarding engine.

Preferably, deleting the label after locating the index with respect to the corresponding entry of the IP NextHop segment table with reference to the label information table comprises: receiving the label packet with the MPLS forwarding engine; searching the corresponding entry of an InSegment Table after confirming an interface address and the label and locating a Cross Connect Table Index with the MPLS forwarding engine; accessing the corresponding entry of the Cross Connect Table Index field of the Cross Connect Table using the Cross Connect Table Index obtained from the InSegment Table and obtaining the OutSegment Index from the OutSegment Index field of the accessed entry with the MPLS forwarding engine; and deleting the label with the MPLS forwarding engine.

Preferably, transmitting the IP packet to the corresponding interface by searching the interface information and the NextHop information after locating the Internet Protocol NextHop segment table comprises: accessing the corresponding entry of the IP NextHop segment table and obtaining the interface information and the NextHop information for the IP routing with the MPLS forwarding engine; and transmitting the IP packet to the corresponding interface with the MPLS forwarding engine.

Preferably, the method further comprises updating the NextHop information of the label information table upon an IP destination address being changed and the NextHop information then being changed in the included routing table with an IP routing module.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of an MPLS edge router;

FIGS. 2A to 2C are label tables;

FIG. 3 is a block diagram of an MPLS protocol stack to which the present invention is applied;

FIG. 4 is a view of an MPLS network to which the present invention is applied;

FIGS. 5A to 5D are extension label tables used in the present invention;

FIG. 6 is a block diagram of an MPLS edge router having multiple look-up load reduction in accordance with an embodiment of the present invention;

FIG. 7A is an extension IP routing table to manage an IP NextHop segment table used in the present invention;

FIG. 7B is an IP NextHop segment table used in an embodiment of the present invention;

FIG. 8 is a block diagram of the MPLS forwarding engine of FIG. 6; and

FIG. 9 is a flowchart of an MPLS edge router in accordance with an embodiment of the present invention.

### DETAILED DESCRIPTION OF THE INVENTION

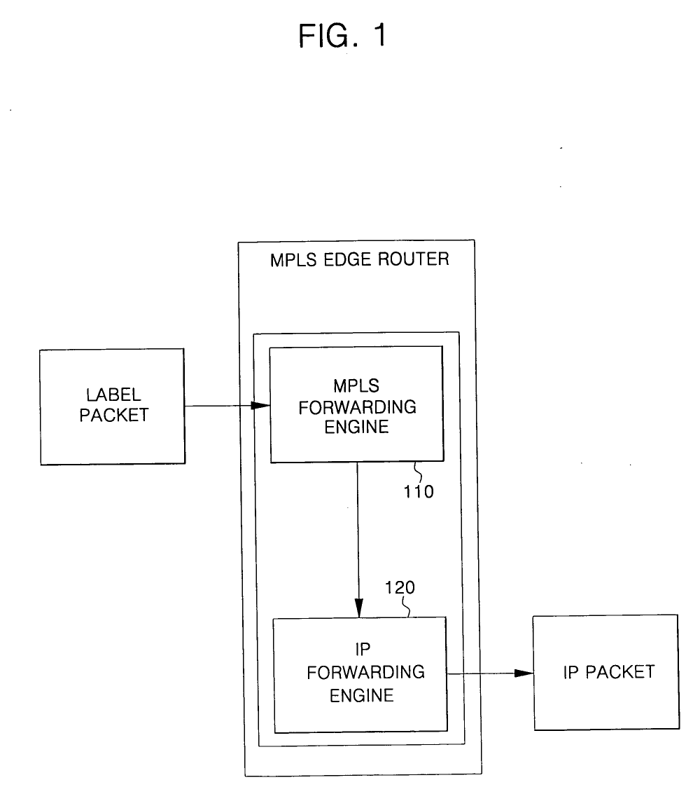

FIG. 1 is a block diagram of an MPLS edge router.

Referring to FIG. 1, in order to add a label packet to an IP packet in an MPLS edge router, an MPLS forwarding engine 110 must look up a label information table and then an IP forwarding engine 120 must look up an IP routing table again.

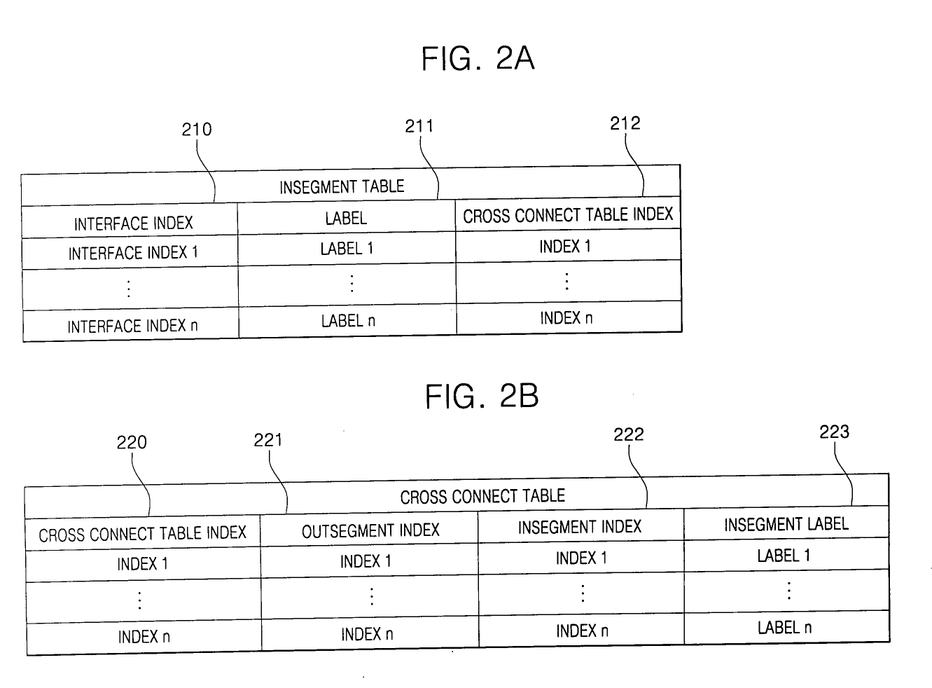

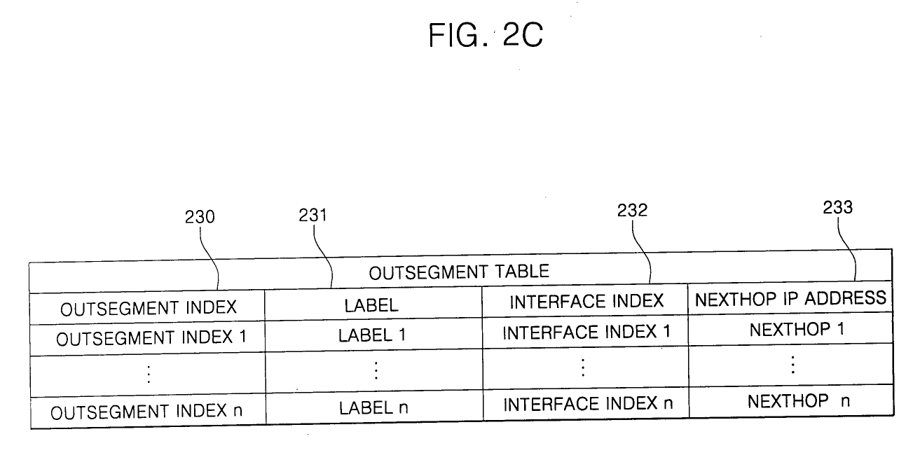

FIGS. 2A to 2C are label tables. FIG. 2A is an InSegment Table for an incoming packet with a label, and FIG. 2C is an OutSegment Table including information to transfer the packet.

FIG. 2B is a Cross Connect Table to connect the InSegment Table to the OutSegment Table.

The InSegment Table of FIG. 2A stores an interface index field 210 to which the packet comes, a label field of the packet 211, the number of pop of the label (not shown) and a traffic parameter (not shown), and includes a Cross Connect Table Index field 212 to look up the Cross Connect Table.

The OutSegment Table of FIG. 2C includes a NextHop IP address field 233 to transfer the packet to the next hop, an outgoing interface index field 232, a label field 231 having information on the number of push of the label (not shown), and an OutSegment Index field 230 which allows a look-up by the Cross Connect Table.

The Cross Connect Table of FIG. 2B has index information fields 220, 221, 222 and 223 used to connect the InSegment Table and the OutSegment Table.

When the MPLS forwarding engine 110 receives a packet having a label, it finds a corresponding entry from the InSegment Table and then finds the entry from a Cross Connect Table that the entry points out. Finally, the MPLS forwarding engine 110 finds an IP address of the next hop to swap, push and pop the label and to forward the packet and the OutSegment Table having an index of the interface, and transmits the label packet to the next hop.

Such a process occurs in an MPLS network core router, and such a packet transfer method enables packet transmission faster than that of the IP routing based on the Longest Match.

When the label packet is transferred to the IP network from the MPLS network, the MPLS forwarding engine 110 deletes all labels of the packet and then transfers the label packet through the IP routing.

That is, when the MPLS forwarding engine 110 receives the label packet, it looks up the label information tables of FIGS. 2A to 2D, deletes the label, and transmits the label packet to the IP forwarding engine 120.

The IP forwarding engine 120 looks up the IP routing table once again. Then, the IP forwarding engine 120 transfers the packet based on the IP routing information. The table look-up is performed twice in order to transfer the label packet to the IP packet in such an MPLS edge router, and since the table look-up is performed one more time than the IP packet transfer, a packet transfer delay occurs.

Generally, a Null value is included in a NextHop field of the corresponding entry of the OutSegment Table that is in the MPLS edge router used to forward packets from the MPLS network to the IP network.

That is, NextHop information in the MPLS edge router is obtained through the IP routing table. Also, even though the NextHop information is obtained in the NextHop field through the IP routing table, when the IP routing table is changed, the changed routing information may not be reflected in the NextHop field.

Hereinafter, an exemplary embodiment of the present invention is described in detail with reference to the accompanying drawings, so as to embody the present invention with ease by a person skilled in the art.

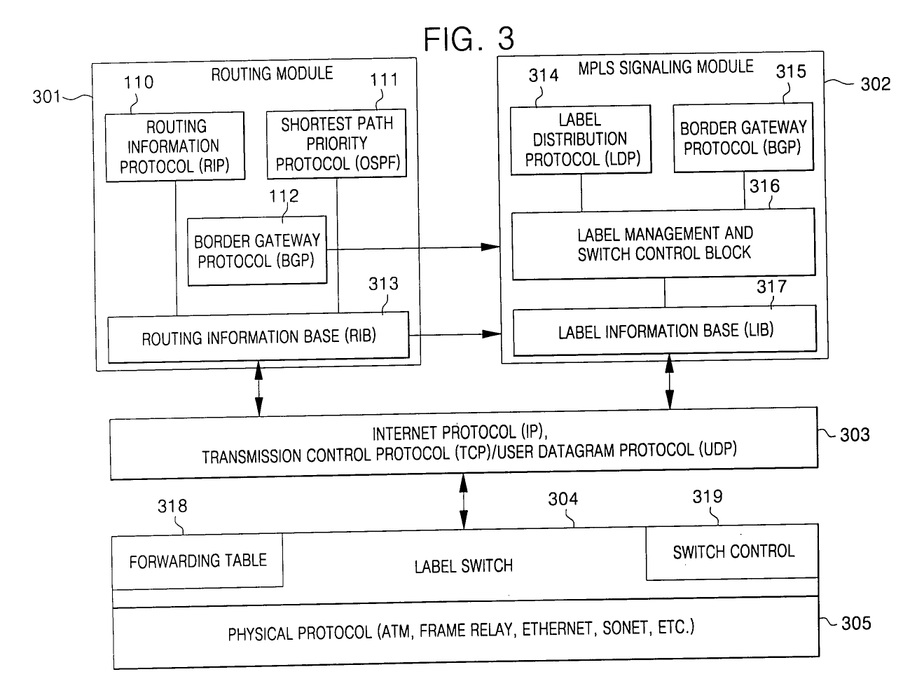

FIG. 3 is a block diagram of an MPLS protocol stack to which the present invention is applied.

Referring to FIG. 3, each MPLS node of an MPLS network has sub-physical layer protocols and may include physical layer equipment 305 such as an Asynchronous Transfer Mode (ATM), a Frame Relay, an Ethernet and a SONET.

A label switch 304 has a forwarding table 318 which forwards a packet when the label switch receives the packet from an upper module, and includes a switch control block 319 which transmits information of the label switch to the upper module and performs a switching function after receiving direct switching control.

A routing module 301 consists of a Routing Information Protocol (RIP) 310 for obtaining routing information between each of the nodes, a Shortest Path Priority Protocol (OSPF) 311, a Border Gateway Protocol (BGP) 312, and a Routing Information Base (RIB) 313 generated by the routing protocol module and these routing protocols.

An MPLS signaling module 302 receives the routing information base (RIB) of the routing module and then allocates and manages the label to enable a label switching on the basis of the RIB. The MPLS signaling module 302 includes a label management and switch control block 316 that controls the label switch and a Label Information Base (LIB) 317 generated on the basis of the RIB 313. The MPLS signaling module 302 also includes a Label Distribution Protocol (LDP) 314 that forwards and receives a label request and mapping message between neighboring nodes, and a BGP 315.

IP and TCP/UDP protocols 303 form a protocol stack to function as a transmission protocol of the routing protocol between neighboring nodes, and a communication protocol based on the existing Internet.

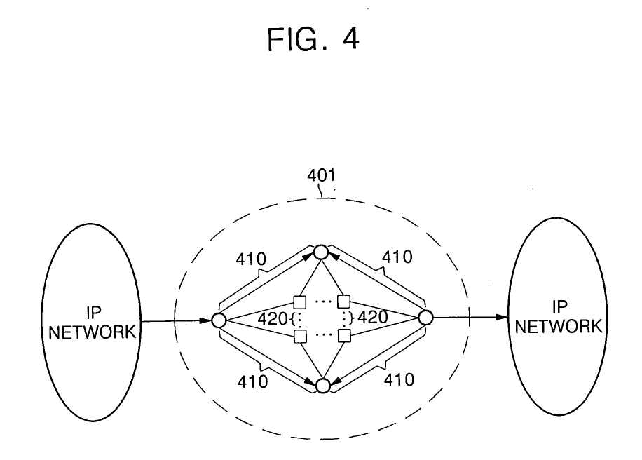

FIG. 4 is an MPLS network to which the present invention is applied.

As shown in FIG. 4, an MPLS network 401 is mutually connected to a plurality of nodes 410 and 420, that is, a plurality of Label Edge Routers (LERs) 410, and a plurality of Label Switch Routers (LSRs) 420.

Each of nodes 410, 420, 420, . . . ,420, 410 sets a fixed path to another node, that is, an LSP by the MPLS signaling protocol according to routing table information or path setting information by an operator, and accordingly, transmission of a real IP packet in the MPLS network 401 is performed through a fixed LSP that has been previously set.

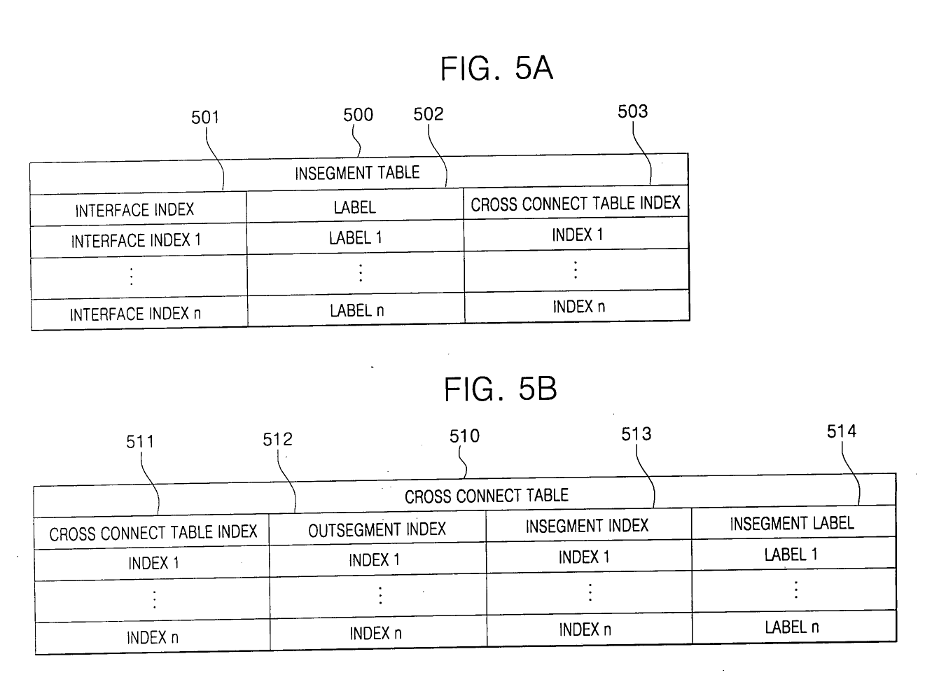

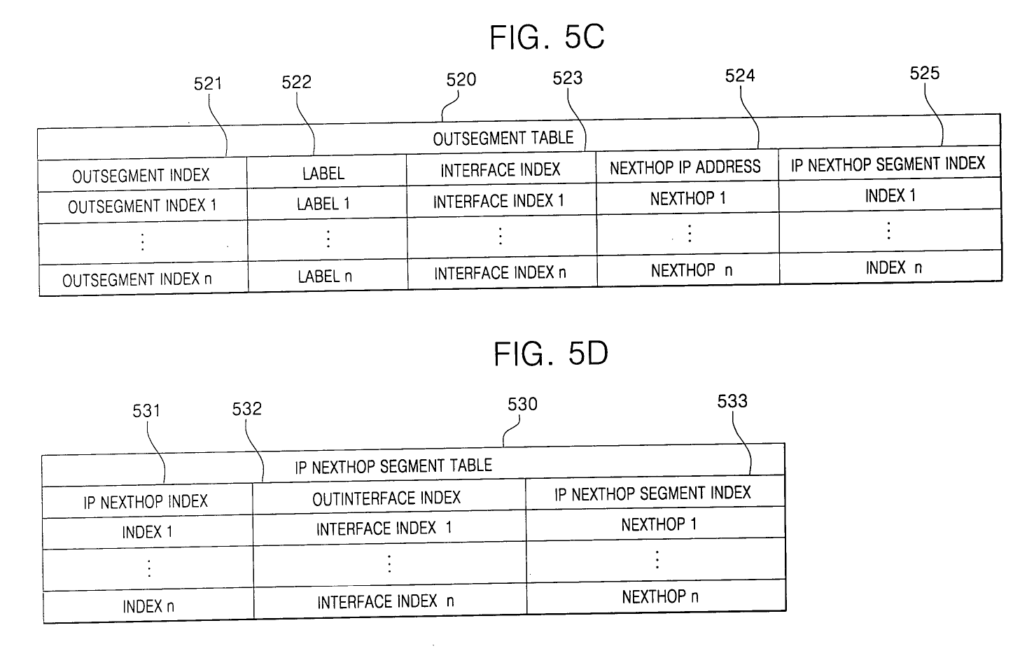

FIG. 5A is an InSegment Table for an incoming packet with a label that is used in an embodiment of the present invention. FIG. 5B is a Cross Connect Table for connecting an InSegment Table and an OutSegment Table used in an embodiment of the present invention. FIG. 5C is an OutSegment Table including information to transfer a packet used in an embodiment of the present invention, and FIG. 5D is an IP NextHop segment table used to obtain IP routing information after deleting the label used in an embodiment of the present invention.

The InSegment Table of FIG. 5A includes an interface index field 501 indicating an interface address used to determine the corresponding entry of the Cross Connect Table from the interface address which received the label packet, a label field 502 indicating a label used to determine the corresponding entry of the Cross Connect Table with a label of the label packet, and a Cross Connect Table Index field 503 used to determine the corresponding entry of the Cross Connect Table.

The MPLS forwarding engine determines the corresponding interface index of the InSegment Table after confirming an interface address which received the label packet.

The MPLS forwarding engine confirms the label of the label packet and determines the corresponding Cross Connect Table Index in which the interface address and the label are identical.

Referring to FIG. 5B, the Cross Connect Table includes a Cross Connect Table Index field 511 having index information used to connect the InSegment Table to the OutSegment Table, an OutSegment Index field 512 providing index information to follow the entry of the OutSegment Table from the corresponding Cross Connect Table Index, an InSegment Index field 513, and an InSegment Label field 514.

The MPLS forwarding engine accesses a corresponding entry of an OutSegment Table identical to the interface address and label of the label packet with reference to the Cross Connect Table 510.

That is, the MPLS forwarding engine accesses the corresponding entry of the Cross Connect Table Index 511 using the Cross Connect Table Index obtained by the InSegment Table 500 and obtains the OutSegment Index from the OutSegment Index 512 of the accessed entry.

Referring to FIG. 5C, the OutSegment Table 520 further includes an OutSegment Index Field 521 used to access the corresponding entry on the basis of the index information of the Cross Connect Table, a label field 522, an interface index field 523 used to transfer the packet to the next hop, a NextHop IP address field 524 used to transfer the packet to the next hop, and an IP NextHop segment index field 525 used to access the corresponding entry of the IP NextHop segment table that provides the IP routing information when a connect network is an IP network.

That is, referring to FIG. 5C, the OutSegment Table further includes an IP NextHop segment index field 525 used to access the corresponding entry of the IP NextHop segment table which provides the IP routing information when the connect network is the IP network, so that the OutSegment Table is extended.

Accordingly, the MPLS forwarding engine determines the corresponding index of the IP NextHop segment table with reference to the IP NextHop segment index field 525 of the OutSegment Table after deleting the label when the received label packet is to be transmitted from the MPLS network to the IP network, and obtains the interface information and the NextHop information for the IP routing by accessing the corresponding entry of the IP NextHop segment table.

Referring to FIG. 5D, an IP NextHop segment table 530 used in an embodiment of the present invention includes an IP NextHop index field 531 having index information with respect to the IP NextHop table to be referred after all labels are deleted by the MPLS forwarding engine, an out interface index field 532 having the interface address for the IP routing, and an IP NextHop segment field 533 having the NextHop information for the IP routing.

The MPLS forwarding engine deletes all labels and then transmits the IP packet with the IP interface information and the NextHop information of the corresponding entry of the IP NextHop segment table.

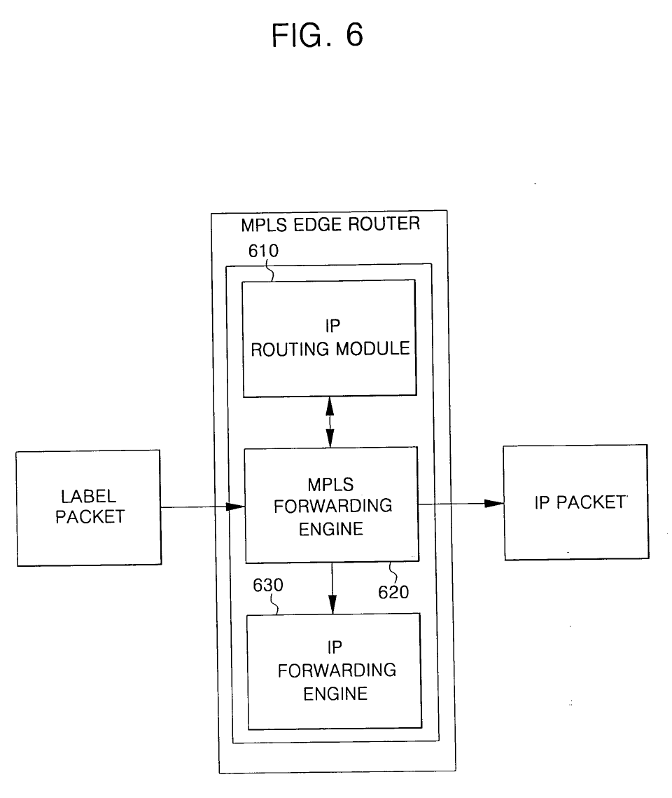

FIG. 6 is a block diagram of an MPLS edge router having multiple look-up load reduction in accordance with an embodiment of the present invention.

Referring to FIG. 6, the MPLS edge router having multiple lookup load reduction in accordance with an embodiment of the present invention includes an IP routing module 610, an MPLS forwarding engine 620, and an IP forwarding engine 630.

The IP routing module 610 provides the IP NextHop segment table of the label information table with the interface address information and the NextHop information. When a change occurs in the IP routing table, the IP routing module applies the changed routing information to the IP NextHop segment table.

When the MPLS forwarding engine 620 receives the label packet, it extracts a label from the received interface address and label packet, accesses the corresponding entry in the InSegment Table, and accesses the index of the Cross Connect Table.

The MPLS forwarding engine 620 accesses the corresponding index of the Cross Connect Table corresponding to the index accessed from the InSegment Table and accesses the Index of the OutSegment.

Then, the MPLS forwarding engine 620 accesses the entry of the corresponding index of the OutSegment Table, accesses the IP NextHop segment index and deletes the label.

Accordingly, the MPLS forwarding engine 620 accesses the entry of the corresponding IP NextHop segment table of the index obtained from the OutSegment Table, accesses the interface address and the NextHop address to which the IP packet should be transferred, and transmits the label deleted IP packet to the corresponding interface.

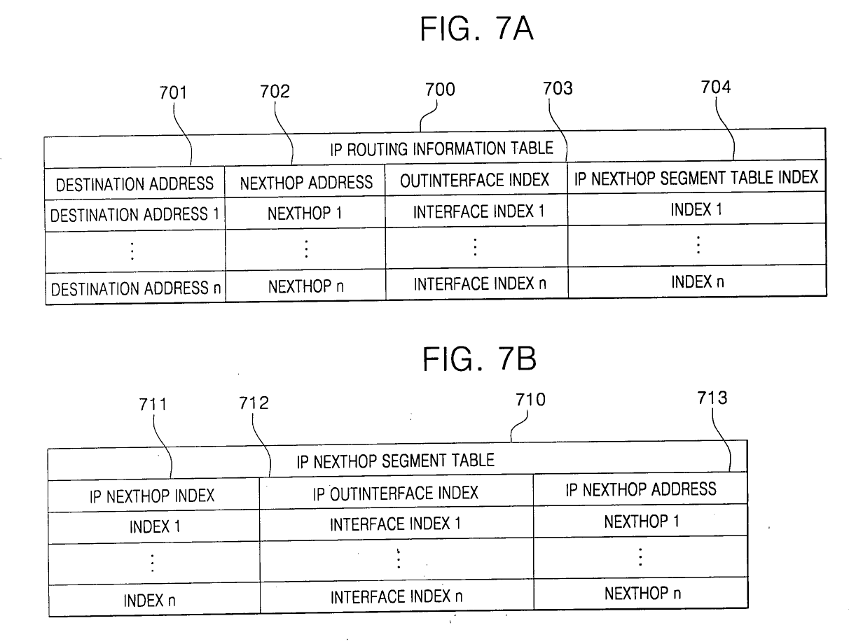

FIG. 7A is an extension IP routing table to manage an IP NextHop segment table used in in an embodiment of the present invention, and FIG. 7B is an IP NextHop segment table used in an embodiment of the present invention.

Referring to FIG. 7A, an extension IP routing information table 700 to manage the IP NextHop segment table includes a destination address field 701 used to obtain the IP routing information from the destination address extracted from the IP packet, a NextHop address field 702 indicating the NextHop address in order to transmit the IP packet to the destination address in the destination address field 701, an out interface index field 703 indicating an interface address to be passed in order to transmit the IP packet from the IP router, and an IP NextHop segment table index field 704 indicating the corresponding entry of the IP NextHop segment table 710 in order that the IP router module updates routing information of the corresponding entry of the IP NextHop segment table 710.

When the routing information in the IP routing information table 700 is changed, the IP routing module updates the routing information of the corresponding entry of the IP NextHop segment table 710 with reference to the IP NextHop segment table index 704.

Referring to FIG. 7B, the IP NextHop segment table used in an embodiment of the present invention includes an IP NextHop index field 711 having index information with respect to the IP NextHop table to be referred by the the MPLS forwarding engine after deleting all labels, an IP out interface index field 712 having the interface address for the IP routing, and an IP NextHop address field 713 having NextHop information for the IP routing.

The MPLS forwarding engine transmits the IP packet with the IP interface information and the NextHop information of the corresponding entry in the IP NextHop segment table after deleting all labels.

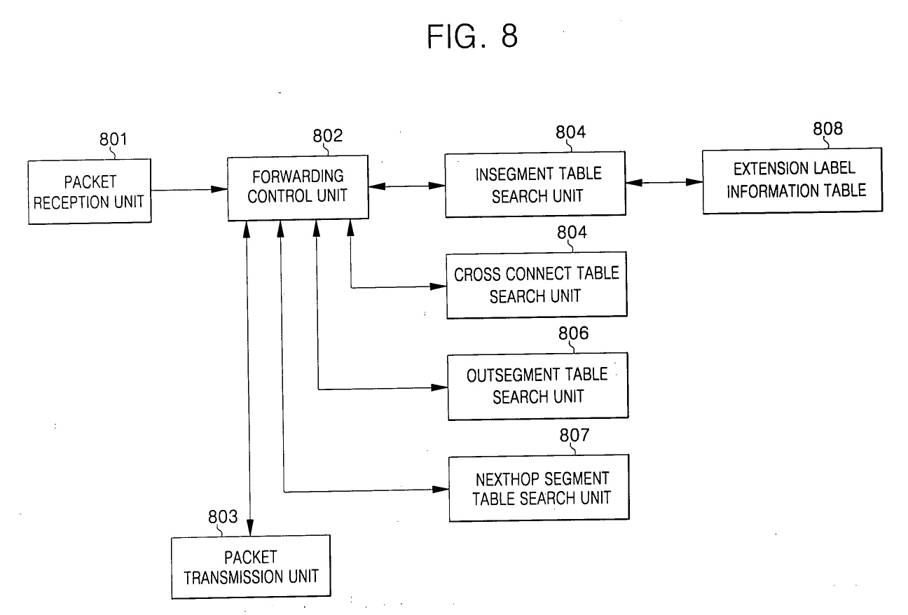

FIG. 8 is a block diagram of the MPLS forwarding engine of FIG. 6.

Referring to FIG. 8, the MPLS forwarding engine includes a packet reception unit 801, a forwarding control unit 802, a packet transmission unit 803, an InSegment Table search unit 804, a Cross Connect Table search unit 805, an OutSegment Table search unit 806, a NextHop segment table search unit 807, and an extension label information table storage unit 808.

The extension label information table storage unit 808 stores an extended OutSegment Table having the IP NextHop segment index and an IP NextHop segment table storing the NextHop information for the IP routing and the interface information to be transmitted to the NextHop.

The packet reception unit 801 receives the label packet and transmits the packet to the forwarding control unit 802. Then, the forwarding control unit 802 extracts interface address and label information, transmits the extracted interface address and label information to the InSegment Table search unit 804 and searches an InSegment Table based on the extracted interface address and label information.

The InSegment Table search unit 804 which has received the interface address and label information from the forwarding control unit 802 accesses the extension label information table 808, searches the InSegment Table, accesses index information of the Cross Connect Table and transmits the information to the forwarding control unit 802.

The forwarding control unit 802 transmits the index information to the Cross Connect Table search unit 805 and searches the Cross Connect Table.

The Cross Connect Table search unit 805, which has received the index information from the forwarding control unit 802, accesses the Cross Connect Table of the extension label information table 808, accesses the index information of the OutSegment Table, and transmits the information to the forwarding control unit 802.

Then, the forwarding control unit 802 transmits the index information to the OutSegment Table search unit 806 and accesses the OutSegment Table to determine the index address of the NextHop segment table.

The forwarding control unit 802 accesses the interface address and the NextHop address for the IP routing by transmitting the index information to the NextHop segment table search unit 807, deletes the label from the label packet and transmits the IP packet to the corresponding interface.

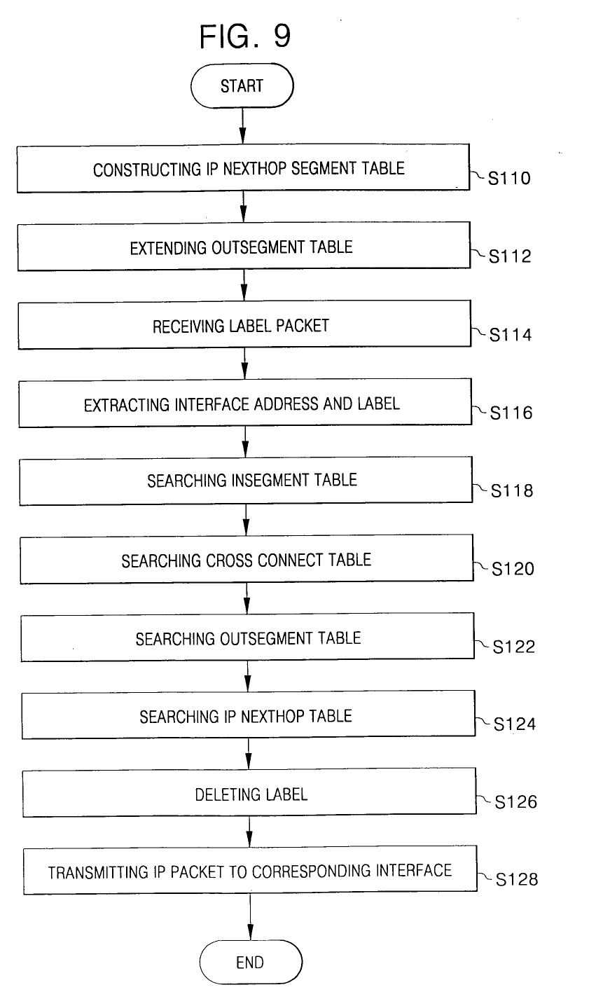

FIG. 9 is a flowchart of an MPLS edge router in accordance with an embodiment of the present invention.

Referring to FIG. 9, at first, an IP NextHop segment table including the interface information and the NextHop information used to transmit the label packet to the IP network is constructed (S110), and the IP NextHop segment table index field to record the index which can follow the corresponding entry of the IP NextHop segment table by extending the OutSegment Table is further included (S112).

Then, when the MPLS forwarding engine receives the label packet (S114), it confirms the interface address and label (S116) and then accesses the Cross Connect Table Index by accessing the corresponding entry of the InSegment Table (S118).

Next, the MPLS forwarding engine accesses the corresponding entry of the Cross Connect Table Index field with the Cross Connect Table Index obtained from the InSegment Table and obtains the OutSegment Index from the OutSegment Index field of the accessed entry (S120).

Then, the MPLS forwarding engine accesses the corresponding index of the IP NextHop segment table with reference to the IP NextHop segment index field of the OutSegment Table when the received label packet is to be transmitted from the MPLS network to the IP network (S122), and accesses the interface information and the NextHop information for the IP routing by accessing the corresponding entry of the IP NextHop segment table (S124).

The MPLS forwarding engine deletes the label (S126), and transmits the IP packet to the corresponding interface (S128).

Although exemplary embodiments and drawings of the present invention have been disclosed for illustrative purposes, those skilled in the art will appreciate that various substitutions, modifications, changes and additions are possible, without departing from the scope and spirit of the invention as recited in the accompanying claims.

According to the present invention, high-speed packet switching of an MPLS can be achieved by decreasing a transfer delay in an MPLS edge router operating as a load when transferring a general label packet.

Also, when a NextHop of a corresponding destination is changed, a label information table can be used without changing it.

1. A Multi-Protocol Label Switching (MPLS) edge router, comprising:
a label information table storage unit adapted to store NextHop information to route a label packet to an Internet Protocol (IP) network and interface information to transmit the label packet to a NextHop;
an Internet Protocol routing module adapted to manage and maintain the label information table storage unit; and
an MPLS forwarding engine adapted to delete a label by accessing the label information table storage unit and searching the interface information and the NextHop information stored therein, and transmitting an IP packet to the corresponding interface upon receiving the label packet to be transmitted to the IP network.

2. The MPLS edge router according to claim 1, wherein the label information table storage unit comprises:
an Internet Protocol NextHop segment table including an index field, an IP out interface index field including an interface address for IP routing, and a NextHop address field including the NextHop information for the IP routing;
an OutSegment Table including an index field, a label field, an interface index field, a NextHop address, and an IP NextHop segment index field adapted to access a corresponding entry of the IP NextHop segment table;
a Cross Connect Table including an Index field, and an OutSegment Index field adapted to access a corresponding entry of the OutSegment Table; and
an InSegment Table including an interface index field of interface addresses to receive label packets, a label field, and a Cross Connect Table Index field adapted to locate a corresponding entry of the Cross Connect Table.

3. The MPLS edge router according to claim 1, wherein the IP routing module is adapted to update the NextHop information of the label information table upon the NextHop information being changed in the included routing table.

4. The MPLS edge router according to claim 1, wherein the MPLS forwarding engine comprises:
a packet reception unit adapted to receive the label packet;
a look-up unit adapted to access the label information table;
a control unit adapted to delete the label by accessing the label information table via the look-up unit, to search the interface information and the NextHop information by accessing the label information table via the look-up unit, and to transmit the IP packet to the corresponding interface information, upon receiving the label packet to be transmitted to the IP network from the packet reception unit; and
a packet transmission unit adapted to transmit the label removed IP packet to the corresponding interface under the control of the control unit.

5. The MPLS edge router according to claim 4, wherein the look-up unit comprises:
an InSegment Table look-up unit adapted to search an index of a Cross Connect Table by accessing an InSegment Table;
a cross connect segment table look-up unit adapted to search an index of an OutSegment Table by accessing a cross connect segment;
an OutSegment Table look-up unit adapted to search an index of an Internet Protocol NextHop segment table by accessing the OutSegment Table; and
an IP NextHop segment table look-up unit adapted to search the interface information and the NextHop information by accessing the IP NextHop segment table.

6. A method of controlling a Multi-Protocol Label Switching (MPLS) edge router, the method comprising:
generating an Internet Protocol NextHop segment table including NextHop information to route a label packet to an Internet Protocol (IP) network and interface information to transmit the label packet to the NextHop;
extending an OutSegment Table to include an index field to access a corresponding entry of the Internet Protocol NextHop segment table in the OutSegment Table consisting of an out interface index field and a NextHop IP address field;
locating an index with respect to a corresponding entry of the IP NextHop segment table with reference to a label information table upon receiving the label packet and deleting the label with an MPLS forwarding engine; and
locating an entry corresponding to the Internet Protocol NextHop segment table index obtained via the label information table from the Internet Protocol NextHop segment table, and transmitting the IP packet to a corresponding interface via the interface information and the NextHop information of the corresponding entry with the the MPLS forwarding engine.

7. The method according to claim 6, wherein deleting the label comprises:
receiving the label packet with the MPLS forwarding engine;
searching a corresponding entry of an InSegment Table after confirming an interface address and the label and locating a Cross Connect Table Index with the MPLS forwarding engine;
accessing a corresponding entry of the Cross Connect Table Index field of the Cross Connect Table using the Cross Connect Table Index obtained from the InSegment Table and obtaining the OutSegment Index from the OutSegment Index field of the accessed corresponding entry with the MPLS forwarding engine; and
deleting the label with the MPLS forwarding engine.

8. The method according to claim 6, wherein transmitting the IP packet to the corresponding interface comprises:
accessing the corresponding entry of the IP NextHop segment table and obtaining the interface information and the NextHop information for the IP routing with the MPLS forwarding engine; and
transmitting the IP packet to the corresponding interface with the MPLS forwarding engine.

9. The method according to claim 6, further comprising updating the NextHop information of the label information table upon an IP destination address being changed and the NextHop information then being changed in the included routing table with an IP routing module.

10. A program storage device, readable by a machine, tangibly embodying a program of instructions executable by the machine to perform a method of controlling a Multi-Protocol Label Switching (MPLS) edge router, the method comprising:
generating an Internet Protocol NextHop segment table including NextHop information to route a label packet to an Internet Protocol (IP) network and interface information to transmit the label packet to the NextHop;
extending an OutSegment Table to include an index field to access a corresponding entry of the Internet Protocol NextHop segment table in the OutSegment Table consisting of an out interface index field and a NextHop IP address field;
locating an index with respect to a corresponding entry of the IP NextHop segment table with reference to a label information table upon receiving the label packet and deleting the label with an MPLS forwarding engine; and
locating an entry corresponding to the Internet Protocol NextHop segment table index obtained via the label information table from the Internet Protocol NextHop segment table, and transmitting the IP packet to a corresponding interface via the interface information and the NextHop information of the corresponding entry with the the MPLS forwarding engine.

11. The program storage device according to claim 10, wherein deleting the label comprises:
receiving the label packet with the MPLS forwarding engine;
searching a corresponding entry of an InSegment Table after confirming an interface address and the label and locating a Cross Connect Table Index with the MPLS forwarding engine;
accessing a corresponding entry of the Cross Connect Table Index field of the Cross Connect Table using the Cross Connect Table Index obtained from the InSegment Table and obtaining the OutSegment Index from the OutSegment Index field of the accessed corresponding entry with the MPLS forwarding engine; and
deleting the label with the MPLS forwarding engine.

12. The program storage device according to claim 10, wherein transmitting the IP packet to the corresponding interface comprises:
accessing the corresponding entry of the IP NextHop segment table and obtaining the interface information and the NextHop information for the IP routing with the MPLS forwarding engine; and
transmitting the IP packet to the corresponding interface with the MPLS forwarding engine.

13. The program storage device according to claim 10, further comprising updating the NextHop information of the label information table upon an IP destination address being changed and the NextHop information then being changed in the included routing table with an IP routing module.
